(19) United States
(12) Patent Application Publication
(10) Pub. No.: US 2016/0215156 A1
(43) Pub. Date: Jul. 28, 2016

(54) INK COMPOSITION FOR INK JET PRINTING AND METHOD FOR MANUFACTURING PRINTED MATTER

(71) Applicant: MIMAKI ENGINEERING CO., LTD., NAGANO (JP)

(72) Inventors: AKIFUMI SEKI, NAGANO (JP); MASARU OHNISHI, NAGANO (JP); HIRONORI HASHIZUME, NAGANO (JP)

(73) Assignee: MIMAKI ENGINEERING CO., LTD., NAGANO (JP)

(21) Appl. No.: 15/002,403

(22) Filed: Jan. 21, 2016

(30) Foreign Application Priority Data
Jan. 22, 2015 (JP) 2015-010672

(51) Int. Cl. C09D 11/36; C09D 11/107; C09D 11/101

(52) U.S. Cl. CPC C09D 11/36; C09D 11/101; C09D 11/107

(57) ABSTRACT

An ink composition for ink jet printing disclosed herein contains hollow particles each including a resin layer having a space inside thereof, a photocurable compound curable by irradiating light, and a solvent added in a quantity which lowers a mixture of the hollow particles and the photocurable compound in viscosity.

### CROSS REFERENCE TO RELATED APPLICATIONS

This application claims the priority benefit of Japanese Patent Application No. 2015-010672, filed on Jan. 22, 2015. The entirety of the above-mentioned patent application is hereby incorporated by reference herein and made a part of this specification.

1. Technical Field

This disclosure relates to an ink composition for ink jet printing and a method for manufacturing a printed matter.

2. Description of the Background Art

Patent Document 1 describes an ink composition containing hollow resin particles.

[Patent Document 1] JP 2010-31196 A (disclosed on Feb. 12, 2010)

### SUMMARY

Titanium oxide, though known for its applicability as a white coloring material, is a substance that settles out. For the reason, an alternative option of the white coloring material in certain cases may be hollow particles.

However, a printed matter, if printed with an ink containing hollow particles and a monomer polymerizable and curable by irradiating light, may be poor in durability. For example, such an image in a printed matter may soon be degraded.

In light of this and other possible disadvantages, this disclosure provides an ink that may provide for a printed matter that excels in durability.

The inventors earnestly worked on this issue, and their pursuit for solutions revealed the inconvenient fact; the monomer included in the ink that entered the insides of the hollow particles was no longer irradiated with light and accordingly left there uncured, and the monomer left uncured flows out over time, tainting a printed surface. This disclosure is presented based on the revealed fact.

An ink composition for ink jet printing disclosed herein contains hollow particles each including a resin layer having a space inside thereof, a photocurable compound curable by irradiating light, and a solvent added in a quantity which lowers viscosity of a mixture of the hollow particles and the photocurable compound.

Adding the solvent may enable the use of photocurable compounds with large molecular weights. The photocurable compounds with larger molecular weights are resultantly increased in viscosity. Using such photocurable compounds with ink jet print devices may be problematic, for example, nozzles may be clogged up. Adding the solvent, however, may decrease the viscosity to a desired level, allowing for the use of photocurable compounds with large molecular weights.

Using a photocurable compound with a large molecular weight may prevent the photocurable compound still uncured from entering and staying in the insides of the hollow particles. The possibility remains that the uncured photocurable compound may enter the insides of the hollow particles through voids between resin molecules constituting the hollow particles. Yet, the possibility is less likely because compounds with larger molecular weights are often larger in volume. In the ink, therefore, the uncured photocurable compound may be unlikely to enter the insides of the hollow particles.

An ink composition for ink jet printing disclosed herein is dischargeable from a head while heating the head, wherein the ink composition contains hollow particles each including a resin layer having a space inside thereof, and a photocurable compound curable by irradiating light.

Heating the head may enable the use of photocurable compounds with large molecular weights. The photocurable compounds with larger molecular weights are resultantly increased in viscosity. Using such photocurable compounds with ink jet print devices may be problematic, for example, nozzles may be clogged up. However, heating the head may decrease the viscosity to a desired level, allowing for the use of photocurable compounds with large molecular weights.

Using a photocurable compound with a large molecular weight may prevent the photocurable compound still uncured from entering and staying in the insides of the hollow particles. The possibility remains that the uncured photocurable compound may enter the insides of the hollow particles through voids between resin molecules constituting the hollow particles. Yet, the possibility is less likely because compounds with larger molecular weights are often larger in volume. In the ink, therefore, the uncured photocurable compound may be unlikely to enter the insides of the hollow particles.

An ink composition for ink jet printing disclosed herein contains hollow particles each including a resin layer having a space inside thereof, and a photocurable compound curable by irradiating light, wherein the resin layer is a porous layer having pore sizes smaller than the molecular length of the photocurable compound.

In the ink composition thus characterized, the photocurable compound may be unlikely to enter the insides of the hollow particles. This prevents the uncured photocurable compound from being left in the hollow particles without being cured, and then from flowing out to taint a printed surface. Therefore, a printed matter that excels in durability may be obtainable. Such an ink may be applicable to various kinds of printed matters desirably highly durable including posters and advertising signs.

Preferably, the ink composition for ink jet printing disclosed herein further contains a photopolymerization initiator, wherein a mixture of the hollow particles, the photocurable compound, and the photopolymerization initiator has a degree of viscosity greater than or equal to 20 mPa·sec. at 25C°, and the solvent is added in a quantity which adjusts the degree of viscosity to be greater than or equal to 3 mPa·sec. and less than or equal to 18 Pa·sec. at 25C°.

Thus, the solvent is added to the mixture having a degree of viscosity greater than or equal to 20 mPa·sec., so that the mixture is diluted and lowered in viscosity to be greater than or equal to 3 mPa·sec. and less than or equal to 18 mPa·sec. which may be low enough for the ink composition to be discharged from the head of an ink jet printer. Then, even the ink composition containing such a molecularly large photocurable compound being difficult to enter the insides of the hollow particles may be rendered adequate for ink jet printing. The ink composition for ink jet printing thus may be provided for a printed matter that excels in durability.

The ink composition for ink jet printing disclosed herein may be further preferably characterized in that the pore sizes are smaller than ½ of the molecular length.

This may further effectively prevent the photocurable compound from entering the insides of the hollow particles. Therefore, a printed matter further improved in durability may be provided. Further advantageously, the printed matter may be improved in safety. For example, the ink composition may be usable for coatings of such articles that pose a greater risk of children putting them in their mouths, such as toys and straps.

More preferably, the ink composition for ink jet printing disclosed herein may further contain a solvent.

Adding the solvent may enable the use of photocurable compounds with large molecular weights. The photocurable compounds with larger molecular weights are resultantly increased in viscosity. Using such photocurable compounds with ink jet print devices may be problematic, for example, nozzles may be clogged up. Adding the solvent, however, may decrease the viscosity to a desired level, allowing for the use of photocurable compounds with large molecular weights.

Using a photocurable compound with a large molecular weight may prevent the uncured photocurable compound from entering and staying in the insides of the hollow particles. The possibility remains that the uncured photocurable compound may enter the insides of the hollow particles through voids between resin molecules constituting the hollow particles. Yet, the possibility is less likely because compounds with larger molecular weights are often larger in volume. In the ink, therefore, the uncured photocurable compound may be unlikely to enter the insides of the hollow particles.

The ink composition for ink jet printing disclosed herein may be further preferably characterized in that each of the hollow particles has an outer shell layer formed from a first resin and an inner wall layer formed of a second resin.

The hollow particle having at least two layers; an outer shell layer and an inner wall layer, may make it difficult for the uncured photocurable compound to enter the inside of the hollow particle, because the voids between resin molecules in one of the outer shell layer and the inner wall layer are partly covered with a surface of the other layer. Preventing the uncured photocurable compound from entering and being left inside the hollow particles may suppress any risks posed by leaving the uncured photocurable compound in the hollow particles.

The ink composition for ink jet printing disclosed herein may be preferably further characterized in that a resin used to form the hollow particles is at least one selected from styrene-acrylic resins and cross-linked products of styrene-acrylic resins, and the photocurable compound is an acrylamide.

The voids between resin molecules constituting the hollow particles are smaller in size than the photocurable compound. The photocurable compound, therefore, may be unlikely to penetrate through the voids. Preventing the uncured photocurable compound from entering and being left inside the hollow particles may suppress any risks posed by leaving the uncured photocurable compound in the hollow particles.

The ink composition for ink jet printing disclosed herein may be preferably further characterized in that the photocurable compound is at least one selected from N-dimethylacrylamide, N-diethylacrylamide, and N-hydroxyethylacrylamide, and the pore sizes are less than or equal to 1 nm.

The ink composition thus characterized may excel in photocurability and further improve the durability of an obtained printed matter.

A method for manufacturing a printed matter disclosed herein includes discharging an ink composition for ink jet printing from a head while heating the head, wherein the ink composition contains hollow particles each including a resin layer having a space inside thereof, and a photocurable compound curable by irradiating light.

Heating the head may enable the use of photocurable compounds with large molecular weights. The photocurable compounds with larger molecular weights are resultantly increased in viscosity. Using such photocurable compounds with ink jet print devices may be problematic, for example, nozzles may be clogged up. Heating the head may decrease the viscosity to a desired level, allowing the use of photocurable compounds with large molecular weights.

Using a photocurable compound with a large molecular weight may prevent the uncured photocurable compound from entering and staying in the insides of the hollow particles. The possibility remains that the uncured photocurable compound may enter the insides of the hollow particles through voids between resin molecules constituting the hollow particles. Yet, the possibility is less likely because compounds with larger molecular weights are often larger in volume. In the ink, therefore, the uncured photocurable compound may be unlikely to enter the insides of the hollow particles.

This disclosure provides for an ink composition that may advantageously prevent an uncured photocurable compound from entering insides of hollow particles and thereby obtain a printed matter that excels in durability.

### BRIEF DESCRIPTION OF THE DRAWINGS

FIGS. 1A and 1B are schematic drawings of exemplified hollow particles included in an ink composition for ink jet printing according to the disclosure.

### DETAILED DESCRIPTION OF EMBODIMENTS

[Ink Composition for Ink Jet Printing]

An ink composition for ink jet printing disclosed herein contains hollow particles each including a resin layer having a space inside thereof, a photocurable compound being curable by irradiating light, and a solvent added in a quantity which lowers a mixture of the hollow particles and the photocurable compound in viscosity.

An ink composition for ink jet printing disclosed herein is dischargeable from a head while heating the head, wherein the ink composition contains hollow particles each including a resin layer having a space inside thereof, and a photocurable compound curable by irradiating light.

An ink composition for ink jet printing disclosed herein contains hollow particles each including a resin layer having a space inside thereof, and a photocurable compound curable by irradiating light, wherein the resin layer is a porous layer having pore sizes smaller than the molecular length of the photocurable compound. The photocurable compound may be unlikely to enter the insides of the hollow particles. This prevents the uncured photocurable compound from being left inside the hollow particles without being cured, later flowing out to taint a printed surface. Therefore, a printed matter that excels in durability may be provided. Such an ink may be applicable to various kinds of printed matters desirably highly durable including posters and advertising signs.

The “molecular length of the photocurable compound” in this description refers to a largest length from one end to another end in the molecular structure of the photocurable compound. The molecular length may be calculated from a molecular structural formula and a total in each bond length. For example, an interatomic length from one terminal atom to another terminal atom in the largest length of a molecule is obtained, and the interatomic lengths of the molecules are summed to calculate the molecular length.

[Hollow Particles]

The hollow particles included in the ink composition for ink jet printing according to the disclosure are each a porous particle having a resin layer with a space inside thereof. For example, the porous particle may have a structure in which a filmy resin layer has a hollow inside.

This disclosure may advantageously prevent the uncured photocurable compound from entering the inside spaces through pores on surfaces of the hollow particles.

More preferably, the pore sizes on the surfaces of the hollow particles may be smaller than the molecular length of the photocurable compound included in the ink composition. By virtue of the ability to substantially prevent the photocurable compound, which is a monomer, from entering the insides of the hollow particles, a printed matter that excels in durability may be provided. Such an ink may be applicable to various kinds of printed matters desirably highly durable including posters and advertising signs.

More preferably, the pore sizes on the surfaces of the hollow particles may be smaller than ½ of the molecular length of the photocurable compound included in the ink composition. This may further effectively prevent the photocurable compound from entering the insides of the hollow particles. Therefore, a printed matter further improved in durability may be provided. Further advantageously, the printed matter may be improved in safety. For example, the ink composition may be usable for coatings of such articles that pose a greater risk of children putting them in their mouths, such as toys and straps.

Specific numerical values of the pore sizes in the hollow particles may be preferably greater than or equal to 0.1 nm. The pore sizes may be desirably less than or equal to 5 μm, more desirably less than or equal to 3 μm, even more desirably less than or equal to 2 μm, particularly desirably less than or equal to 200 nm, and most desirably less than or equal to 1 nm.

The hollow particle, because of its hollow inside, is relatively small in specific gravity and unlikely to settle out. Therefore, a photocurable ink in which the settling of a pigment is unlikely to occur may be provided. Since diffused reflection of light on the exterior of the hollow particle can produce white color, the ink composition may be preferably usable as a white ink.

The hollow particles, which are used as an ink pigment and unlikely to settle out, may provide for the following advantages. Conventionally, some print devices may be equipped with an ink circulation mechanism to prevent the pigment from settling out. Such a mechanism may become unnecessary. Additionally, in order to prevent the ink pigment from settling out in the head or discharge the settled pigment from the head, the ink in the head may be forced out to refresh the ink whenever printing is inactive. The ink discharge for this purpose may become unnecessary to lessen useless consumption of the ink.

The material of the hollow particles may be selected from but is not limited to resins. The resin used to form the hollow particles may be one selected from acrylic resins, styrene resins, styrene-acrylic resins, and methyl methacrylate resins.

Of these examples, styrene-acrylic resins may be preferably used. The styrene-acrylic resin selected and used may be cross-linked. The hollow particles formed from any one selected from these resins may have surficial pores smaller in size. This may effectively prevent the uncured photocurable compound from entering the insides of the hollow particles.

More preferably, the resin used to form the hollow particles may be at least one selected from styrene-acrylic resins and cross-linked products of styrene-acrylic resins, and the photocurable compound may be an acrylamide. The hollow particles formed from any one selected from these resins may have intermolecular voids smaller in size than the photocurable compound. This may effectively prevent the photocurable compound from penetrating through the voids.

The ink composition for ink jet printing disclosed herein may be further preferably characterized in that the hollow particles each have an outer shell layer formed from a first resin and an inner wall layer formed from a second resin. Any voids in the outer shell layer may be sealable by the inner wall layer to prevent the uncured photocurable compound from entering the insides of the hollow particles.

As with some given examples of the resin used to form the hollow particles, examples of the first resin may preferably include acrylic resins, styrene resins, styrene-acrylic resins, and methyl methacrylate resins. Of these examples, styrene-acrylic resins may be particularly preferable. The styrene-acrylic resin selected and used may be cross-linked. Specific examples suitably used may include SX8782(D) and SX866(B) supplied by JSR Corporation.

The second resin may be a different material than the first resin or the same material as the first resin. Supposing that the same material is used, the hollow structure is formed from the first resin, and the inner wall layer is then formed from the second resin in the hollow part. Since voids formed in the outer shell layer and the inner wall layer may be sealable by the other layer, it may be difficult for the uncured photocurable compound to penetrate through to the inner side of the inner wall layer.

Specific examples of the second resin, in perspective of refractivity and solubility, are given below. Preferably, the second resin may be at least one selected from the group consisting of fluororesins (including polytetrafluoroethylene, Teflon (registered trademark), CYTOP (available from ASAHI GLASS CO., LTD.), acrylic resins (including polyacrylic resins, sodium polyacrylate resins), methacrylic resins (including polymethyl methacrylic resins), styrene-based resins (including polystyrene resins), and polycarbonate-based resins (including polycarbonate resins). Further preferably, the second resin may be at least one selected from the group consisting of non-amorphous fluororesins including CYTOP (ASAHI GLASS CO., LTD.).

In the hollow particle in which the outer shell layer and the inner wall layer are tightly adhered to each other, voids between resin molecules in one of the outer shell layer and the inner wall layer are covered with a surface of the other layer. Despite any interval between the outer shell layer and the inner wall layer, providing a double layered structure formed by the outer shell layer and the inner wall layer may make it difficult for the uncured photocurable compound to penetrate through to the inner side of the inner wall layer.

The hollow particles having such outer shell layers and inner wall layers may be produced by, for example, a method described in the Patent Document 1 (JP 2010-31196 A).

Preferably, the pore sizes on the surface of the hollow particles may be greater than or equal to 0.1 nm and less than or equal to 1 nm, and the molecular length of the photocurable compound may be greater than or equal to 1 nm and less than or equal to 5 μm. As far as the voids between resin molecules constituting the hollow particles and the molecular length in the lengthwise direction of the photocurable compound stay in their before-mentioned numerical ranges, the photocurable compound is surely larger in size than the voids and unlikely to penetrate through the voids.

The particle sizes of the hollow particles may be selected from various sizes depending on, for example, desired colors. The particle sizes may be preferably greater than or equal to 0.2 μm, and more preferably greater than or equal to 0.4 μm. Further, the particle sizes may be preferably less than or equal to 1.1 μm, more preferably less than or equal to 1.0 μm, and particularly preferably less than or equal to 0.8 μm. By regulating the particle sizes to be greater than or equal to 0.2 μm, favorable color tones (for example, white) may be provided. Regulating the particle sizes to be less than or equal to 1.1 μm may prevent the particles from settling out to attain favorable dispersibility of the particles.

As for the hollow particle having the outer shell layer and the inner wall layer, specific values of the particle size given earlier refer to the size of the outer shell layer. The inner wall layer, on the other hand, is not particularly limited as far as it is small enough to be encased in the outer shell layer.

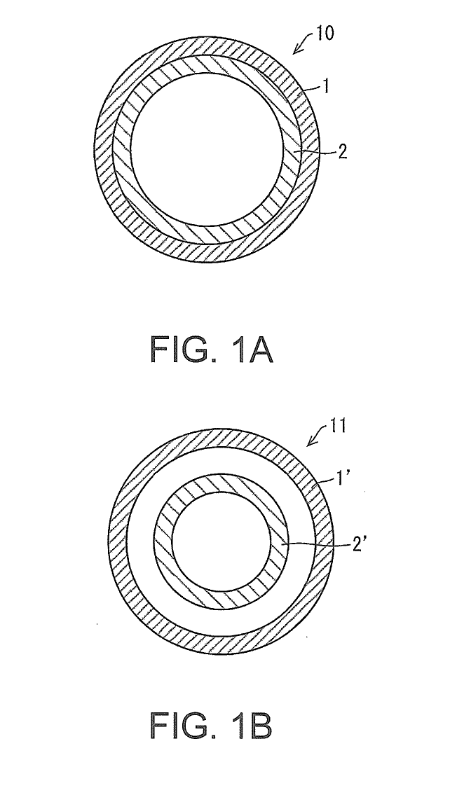

Referring to FIGS. 1A and 1B, a description is given below to the hollow particles included in the ink composition for ink jet printing according to the disclosure. FIGS. 1A and 1B are schematic drawings of exemplified hollow particles included in an ink composition for ink jet printing according to the disclosure.

As illustrated in FIG. 1A, a hollow particle 10 illustrated as an example of the hollow particle has an outer shell layer 1 and an inner wall layer 2. There is a space on the inner side of the inner wall layer 2. By virtue of tight adhesion between the outer shell layer 1 and the inner wall layer 2, voids between resin molecules in one of the outer shell layer 1 and the inner wall layer 2 may be covered with a surface of the other layer. Then, it may be difficult for the uncured photocurable compound to penetrate through the voids.

Another example of the hollow particle is illustrated in FIG. 1B as a hollow particle 11 having an outer shell layer 1′ and an inner wall layer 2′. There is a space on the inner side of the inner wall layer 2′. The outer shell layer 1′ and the inner wall layer 2′, instead of being tightly adhered to each other, are spaced at an interval. Providing a double layered structure formed by the outer shell layer 1′ and the inner wall layer 2′ may make it difficult for the uncured photocurable compound to penetrate through to the inner side of the inner wall layer.

[Photocurable Compound]

The photocurable compound included in the ink composition for ink jet printing according to the disclosure is not particularly limited to any particular materials as far as they are curable when irradiated with light. Examples of the photocurable compound may include curable monomers and curable oligomers polymerizable when irradiated with ultraviolet light. The curable monomers may include, for example, low-viscosity acrylic monomers, vinyl ethers, oxetane-based monomers, or aliphatic cyclic epoxy monomers. The curable oligomers may include, for example, acrylic oligomers.

Of these examples, acrylamides are preferably used. Particularly preferable examples may be N-dimethylacrylamide, N-diethylacrylamide, and N-hydroxyethyl acrylamide. The ink composition may contain any one selected from these materials or a mixture of two or more of them. The exemplified materials are molecularly large and unlikely to penetrate through the surficial pores of the hollow particles.

When the photocurable compound is selected from N-dimethylacrylamide, N-diethylacrylamide, and N-hydroxyethyl acrylamide having molecular lengths less than or equal to 1 nm, the pore sizes on the surface of the hollow particles may be preferably less than or equal to 1 nm.

Preferably, the resin used to form the hollow particles may be at least one selected from styrene-acrylic resins and cross-linked products of styrene-acrylic resins, and the photocurable compound may be an acrylamide. The hollow particles formed from any one selected from these resins may have intermolecular voids smaller in size than the photocurable compound. This may effectively prevent the photocurable compound from penetrating through the voids.

[Solvent]

More preferably, the ink composition for ink jet printing disclosed herein may further contain a solvent. The solvent may be non-limitingly selected from various materials.

Adding the solvent may enable the use of photocurable compounds with large molecular weights. The photocurable compounds with larger molecular weights are resultantly increased in viscosity. Using such photocurable compounds with ink jet print devices may be problematic, for example, nozzles may be clogged up. Adding the solvent, however, may decrease the viscosity to a desired level, allowing the use of photocurable compounds with large molecular weights.

Using a photocurable compound with a large weight average molecular weight may prevent the uncured photocurable compound from entering and staying in the insides of the hollow particles. The possibility remains that the uncured photocurable compound may enter the insides of the hollow particles through voids between resin molecules constituting the hollow particles. Yet, the possibility is less likely because compounds with larger molecular weights are often larger in volume. The uncured photocurable compound, if left in the hollow particles, would later leak out of an obtained printed matter. This may pose the risk of causing negative effects on the human body. Using a photocurable compound with a large molecular weight may prevent the uncured photocurable compound from entering and staying in the insides of the hollow particles, thereby avoiding the risk.

Possibly, the solvent, as well as the photocurable compound, may enter the insides of the hollow particles. The solvent, if having entered and remaining the insides of the hollow particles, is volatilized and released while the printed matter is being dried.

An organic solvent that may be included in the solvent-added UV curable ink described herein may be preferably a solvent in which the photocurable compound is soluble. Examples of the organic solvent may include hydrocarbon-based solvents, alcohols, ester-based solvents, ether-based solvents, ketone-based solvents, and glycol derivatives.

The glycol derivatives may include glycol ethers and glycol ether acetates, examples of which may be propylene glycol monomethyl ether, ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, ethylene glycol monomethyl ether propionate, ethylene glycol monoethyl ether propionate, ethylene glycol monobutyl ether propionate, diethylene glycol monomethyl ether propionate, diethylene glycol monoethyl ether propionate, diethylene glycol monobutyl ether propionate, propylene glycol monomethyl ether propionate, dipropylene glycol monomethyl ether propionate, ethylene glycol monomethyl ether butyrate, ethylene glycol monoethyl ether butyrate, ethylene glycol monobutyl ether butyrate, diethylene glycol monomethyl ether butyrate, diethylene glycol monoethyl ether butyrate, diethylene glycol monobutyl ether butyrate, propylene glycol monomethyl ether butyrate, and dipropylene glycol monomethyl ether butyrate.

The hydrocarbon-based solvents may include, for example, aromatic hydrocarbon-based solvents, chlorinated hydrocarbon-based solvents, cycloaliphatic hydrocarbon-based solvents, and aliphatic hydrocarbon-based solvents. Specific examples may include n-hexane, n-heptane, n-octane, isooctane, cyclohexane, methyl cyclohexane, benzene, toluene, o-xylene, m-xylene, p-xylene, and ethylbenzene.

The ester-based solvents may include, for example, propyl formate, formic acid-n-butyl, isobutyl formate, amyl formate, ethyl acetate, acetic acid-n-propyl, isopropyl acetate, acetic acid-n-butyl, isobutyl acetate, secondary butyl acetate, acetic acid-n-amyl, isoamyl acetate, methyl isoamyl acetate, secondary hexyl acetate, methyl propionate, ethyl propionate, propionic acid-n-butyl, methyl butyrate, ethyl butyrate, methyl lactate, and γ-butyrolactone.

The ketone-based solvents may include, for example, methyl ethyl ketone, methyl-n-propyl ketone, methyl-n-butyl ketone, methyl isobutyl ketone, diethyl ketone, ethyl-n-butyl ketone, di-n-propyl ketone, and mesityl oxide.

Any one of these exemplified solvents may be singly used, or two or more of them having different boiling points may be optionally combined and used in perspective of solubility of an infiltration inhibitor to be used, discharge stability of the ink, and dryness of the ink on a target recording medium.

Preferably, the solvent may be added in a quantity which lowers a mixture of the hollow particles and the photocurable compound in viscosity. When a mixture of the hollow particles, photopolymerization initiator, and photopolymerization initiator is greater than or equal to 20 mPa·sec. in viscosity at 25C°, the solvent may be preferably added in a quantity which adjusts the degree of viscosity to be greater than or equal to 3 mPa·sec. and less than or equal to 18 mPa·sec. at 25C°. For the whole quantity of the ink composition, the solvent content may be preferably greater than or equal to 10% by weight and less than or equal to 90% by weight, and more preferably greater than or equal to 40% by weight and less than or equal to 80% by weight.

[Other Ingredients]

In addition to the ultraviolet-curable compound, metal particles, and solvent, the ink composition for ink jet printing according to the disclosure may further contain other ingredients to an extent that does not undermine the properties of the ink composition for ink jet printing. The other additional ingredients may include various additives, for example, photopolymerization initiators, chain transfer agents, leveling agents, dispersants, infiltration accelerators, humectants, fixing agents, mildewproofing agents, antiseptic agents, antioxidants, chelating agents, thickeners, sensitizers (sensitizing dyes), stabilizers, coloring agents (other than metal particles), anti-settling additives, and light stabilizers. The light stabilizers may include hindered amine-based light stabilizers.

The photopolymerization initiators may include,for example, 1-hydroxycyclohexyl phenyl ketone, 2-benzyl-2-dimethylamino-1-(morpholinophenye-butanone-1,2,2-dimethoxy-2-phenylacetop henone, bis(2,4,6-trimethyl benzoyl)phenylphosphine oxide, and 2-methyl-1-(4-methylthiophenyl)-2-morpholinopropane-1-one. Any one of these examples may be singly used, or two or more of them may be jointly used.

The chain transfer agents may include, for example, 2-mercaptobenzothiazole, γ-mercaptoxypropyl trimethoxysilane, and 2,4-diphenyl-4-methylpentene.

[Applications of Ink Composition]

The ink composition for ink jet printing according to the disclosure, particularly when no solvent is added thereto, may be preferably used by being discharged from a printer head while the head is being heated.

Heating the head may enable the use of photocurable compounds with large molecular weights. The photocurable compounds with larger molecular weights are resultantly increased in viscosity. Using such photocurable compounds with ink jet print devices may be problematic, for example, nozzles may be clogged up. Heating the head, however, may decrease the viscosity to a desired level, allowing for the use of photocurable compounds with large molecular weights. In the obtained ink, therefore, the uncured photocurable compound may be unlikely to enter the insides of the hollow particles.

The head may be heated at temperatures suitably adjusted for the ingredients and aimed viscosity of the ink. The heating temperature is preferably greater than or equal to 15° C. and less than or equal to 60° C.

Overheating the head may cause damage to the used ink jet print device, volatilize the ink, or degrade the ingredients of the ink. If the ink ingredients are such that a degree of viscosity low enough is not attainable unless the head is heated at high temperatures beyond a range of heating temperatures tolerable for the head, the solvent may be preferably added to adjust the viscosity.

The implementations of this disclosure are not necessarily limited to the embodiments described so far and may be carried out in many other forms. The technical scope of this disclosure encompasses any modifications within its scope defined by the appended claims and embodiments obtained by variously combining the technical means disclosed herein.

### INDUSTRIAL APPLICABILITY

This disclosure may be applicable to the field of printing techniques including ink jet printing.

What is claimed is:

1. An ink composition for ink jet printing, comprising:
hollow particles each including a resin layer having a space inside thereof;
a photocurable compound curable by irradiating light; and
a solvent added in a quantity which lowers a mixture of the hollow particles and the photocurable compound in viscosity.

2. An ink composition for ink jet printing dischargeable from a head while heating the head, the ink composition comprising:
hollow particles each including a resin layer having a space inside thereof; and
a photocurable compound curable by irradiating light.

3. An ink composition for ink jet printing, comprising:
hollow particles each including a resin layer having a space inside thereof; and
a photocurable compound curable by irradiating light, wherein
the resin layer is a porous layer having pore sizes smaller than a molecular length of the photocurable compound.

4. The ink composition for ink jet printing according to claim 1, further comprising a photopolymerization initiator, wherein
a mixture of the hollow particles, the photocurable compound, and the photopolymerization initiator is greater than or equal to 20 mPa·sec. in viscosity at 25C°, and
the solvent is added in a quantity which adjusts the viscosity to between 3 mPa·sec. and 18 mPa·sec. at 25C°.

5. The ink composition for ink jet printing according to claim 3, wherein the pore sizes are smaller than ½ of the molecular length.

6. The ink composition for ink jet printing according to claim 2, further comprising a solvent.

7. The ink composition for ink jet printing according to claim 1, wherein the resin layer comprises an outer shell layer including a first resin and an inner wall layer including a second resin.

8. The ink composition for ink jet printing according to claim 1, wherein
a resin used to form the hollow particles is at least one selected from styrene-acrylic resins and cross-linked products of styrene-acrylic resins, and
the photocurable compound is an acrylamide.

9. The ink composition for ink jet printing according to claim 1, wherein
the photocurable compound is at least one selected from N-dimethylacrylamide, N-diethylacrylamide, and N-hydroxyethyl acrylamide, and
the resin layer is a porous layer having pore sizes less than or equal to 1 nm.

10. A manufacturing method for printed matter comprising discharging an ink composition for ink jet printing from a head while heating the head, wherein
the ink composition comprises:
hollow particles each including a resin layer having a space inside thereof; and
a photocurable compound curable by irradiating light.
